(19) United States
(12) Patent Application Publication
(10) Pub. No.: US 2023/0184464 A1
(43) Pub. Date: Jun. 15, 2023

(54) SYSTEMS AND METHODS FOR MOUNTING A HELIOSTAT

(71) Applicant: SOLAR DYNAMICS LLC, Broomfield, CO (US)

(72) Inventors: Nathaniel STEGALL, Broomfield, CO (US); Kyle KATTKE, Broomfield, CO (US); Rick SOMMERS, Broomfield, CO (US)

(73) Assignee: SOLAR DYNAMICS LLC, Broomfield, CO (US)

(21) Appl. No.: 17/924,729

(22) PCT Filed: May 11, 2021
(86) PCT No.: PCT/US2021/031813

§ 371 Date: Nov. 11, 2022

Related U.S. Application Data
(60) Provisional application No. 63/023,648, filed on May 12, 2020.

(51) Int. Cl. F24S 30/452; F24S 23/70

(52) U.S. Cl. CPC F24S 30/452; F24S 23/70; F24S 2030/134

(57) ABSTRACT

A mounting system for a heliostat is provided that allows the heliostat to move with respect to two orthogonal axes to track the sun. The mounting system has features that allow the heliostat to precisely and accurately move about these axes even as various components degrade during operation in harsh environments and over long time periods. Embodiments of the mounting system can have a frame that supports multiple mirrors and translates forces from the mirrors to multiple hubs that move about a circular track. One of the hubs can include a fewer number of contact points to accommodate a circular track that is out of round. In addition, an actuator that moves the hubs around the circular track can be biased into the track to also accommodate a circular track that is out of round.

### GOVERNMENT LICENSE RIGHTS

This invention was made with government support under grant DE-EE0008024 awarded by the U.S. Department of Energy. The government has certain rights in the invention.

### CROSS-REFERENCE TO RELATED APPLICATIONS

This application claims the benefit of U.S. Provisional Pat. Application Serial No. 63/023,648, filed May 12, 2020, the entire disclosure of which is hereby incorporated herein by reference.

### FIELD

The present disclosure is directed to a mounting system for a heliostat, and more specifically to a frame that extends from mirrors to a circular track of the heliostat, hubs that are movable about the circular track, and an actuator that moves a hub about the circular track.

### BACKGROUND

A heliostat is an apparatus that reflects light or radiation toward a central point or tower where the radiation is collected from multiple heliostats to generate power. In these concentrating solar power plants, the radiation heats a fluid, sometimes to change the state of the fluid, which in turn powers a turbine that produces electricity. An individual heliostat may comprise an array of mirrors that are movable about two orthogonal axes to track the apparent movement of the sun throughout the day. The orientation of a heliostat can be controlled with a controller device that moves the heliostat in response to the predicted position of the sun as well as other conditions experienced by the heliostat.

These large scale solar power systems are often located in harsh environments such as deserts. In addition, a heliostat, by design, is continuously exposed to sunlight, which can degrade parts of the heliostat and the mounting system that moves and supports the mirrors of the heliostat. Moreover, the mounting system of the heliostat may be constructed with looser tolerances to reduce the cost of manufacturing. With harsh conditions and looser tolerances, the heliostat and the mounting system can warp, deflect, and generally become out of alignment over long time periods. Thus, there is a need for a heliostat with a mounting system that can maintain accurate and precise orientation of the heliostat when a circular track or other components have changed, deflected, or warped in harsh environments over long time periods.

### SUMMARY

The above shortcomings and other needs are addressed by the various embodiments and configurations of the present disclosure. Embodiments of the present disclosure provide a heliostat with a carousel type of mounting system that has a frame that translates forces from multiple mirrors to a plurality of hubs on a circular track. In further embodiments of the present disclosure, hubs and an azimuth actuator that can accurately and precisely control the position of the mirrors of the heliostat when a circular track or other components have changed, deflected, or warped in harsh environments over long time periods are presented.

Embodiments of the present disclosure provide a frame that extends from three connection points across a support positioned behind mirrors of a heliostat to multiple hubs that rotate about a circular track. In some embodiments, the frame comprises two support members that extend from a left connection point on the support down to two of the hubs, three support members extend from a center connection point to all hubs, and two support members extend from a right connection point to two of the hubs. This frame arrangement distributes forces across the support such that the support can be made with less mass, which reduces costs. In addition, wind and other forces that act on the heliostat are better distributed through the frame and among the plurality of hubs, which improves the longevity of the heliostat.

Further embodiments of the present disclosure provide a hub arrangement that accommodates warping or deflection of the circular track and other parts of the heliostat. A mounting system for a heliostat as described herein has multiple hubs that are movable around a circular track. In various embodiments, one hub is driven, and the other two hubs are idler or non-driven hubs. The two idler hubs bear the weight of the frame and mirrors and are secured to the track in, for example, both vertical and horizontal directions. The driven hub has one or more actuators that move the driven hub about the circular track, and the driven hub can have fewer points of contact with the circular track compared to the idler hubs. Therefore, the driven hub bears the weight of the frame and mirrors but is secured in fewer directions compared to the idler hubs. For instance, the driven hub may only be secured to the circular track in the vertical direction. In this manner, the driven hub accommodates warping or deflection in the circular track. Thus, the mounting system can accurately and precisely orient the mirrors of the heliostat, even in harsh environments over long time periods.

It is another aspect of the present disclosure to provide an azimuth actuator that drives one of the hubs about the circular track and that also accommodates warping or deflection in the circular track. The azimuth actuator can be connected to a driven hub, and the azimuth actuator can also be biased in a direction substantially perpendicular to a central axis of the cross section of the circular track such that the azimuth actuator is biased into teeth extending from the circular track. Thus, when encountering part of a circular track that has deflected or warped, the azimuth actuator can deflect away or toward the circular track to accommodate the deflection or warping. In addition, the biasing force helps reduce or prevent swaying between the hubs and the circular track in response to wind or other forces acting on the mirrors or other parts of the heliostat. However, it will be appreciated that the teeth can extend from the track in any direction to provide an operable engagement with the azimuth actuator. For example, the teeth can extend from an inner surface of the track, an upper surface of the track, etc. In addition, the azimuth actuator can be biased in a direction other than substantially perpendicular to the central axis of the cross section of the circular track to bias the azimuth actuator into the teeth of the track.

During operation, the azimuth actuator rotates a plurality of rollers into the teeth of the circular track to move the driven hub about the circular track. Each tooth has two sides that descend from a tip, and each side has a flat portion that the rollers contact. With this arrangement, at least one roller contacts two flat portions of the teeth of the circular track, which helps reduce or prevent swaying between the hubs and the circular track.

It is a further aspect of the present disclosure to provide a mounting system that can be used for various mirror sizes. In one example, the mirrors have an area of approximately 27 m². In various embodiments, the mirrors can have an area of between approximately 19 to 170 m². Further still, it will be appreciated that aspects of the mounting system described herein can be used for applications besides controlling the orientation of the mirrors of the heliostat. For example, apparatuses such as radomes or other similar structures that rotate antennae can incur the benefits of the mounting system described herein.

One particular embodiment of the present disclosure is a mounting system for a heliostat, comprising a support having a left connection point, a center connection point, and a right connection point; a circular track; and a left idler hub, a right idler hub, and a driven hub, wherein the hubs are configured to move about the circular track; two support members extending from the left connection point, wherein one of the support members extending from the left connection point is connected to the left idler hub, and one of the support members extending from the left connection point is connected to the driven hub; three support members extending from the center connection point, wherein one of the support members extending from the center connection point is connected to the left idler hub, one of the support members extending from the center connection point is connected to the driven hub, and one of the support members extending from the center connection is connected to the right idler hub; and two support members extending from the right connection point, wherein one of the support members extending from the right connection point is connected to the driven hub, and one of the support members extending from the right connection point is connected to the right idler hub.

In various embodiments, the mounting system further comprises an elevation actuator positioned proximate to the driven hub and connected to a point that is offset from an elevation axis, wherein the left connection point, the center connection point, and the right connection point are arranged along the elevation pivot axis, wherein the elevation actuator extends and retracts to rotate the support about the elevation pivot axis.

In some embodiments, the mounting system further comprises an azimuth actuator connected to the driven hub, the azimuth actuator having a plurality of rollers are arranged in a circular pattern, and the azimuth actuator rotates the plurality of rollers about a center axis of the circular pattern; and a plurality of teeth extending from the circular track, wherein the plurality of rollers is operably engaged with the plurality of teeth, the azimuth actuator and the plurality of rollers are biased against the plurality of teeth, and rotation of the rollers against the teeth moves the driven hub about the circular track. In various embodiments, wherein each tooth of the plurality of teeth has two sides that descend from a tip, and each side has a flat portion, wherein at least one roller of the plurality of rollers is engaged to the flat portions of adjacent teeth to prevent backlash between the plurality of rollers and the plurality of teeth.

In some embodiments, the mounting system further comprises a first support member extending from the driven hub to the left idler hub; and a second support member extending from the driven hub to the right idler hub. In some embodiments, the mounting system further comprises a first support member extending between the driven hub and the left idler hub; a second support member extending between the driven hub and the right idler hub; and a third support member extending between the left idler hub and the right idler hub. In various embodiments, the support members extending from the left connection point, the center connection point, and the right connection point to the left idler hub and right idler hub are arranged in a common plane and form a “W” shape. In some embodiments, the support is connected to a rear surface of each mirror of a plurality of mirrors.

Another particular embodiment of the present disclosure is a hub system for a heliostat, comprising: a support connected to a circular track, wherein a plurality of support members extends from the support to at least three hubs that are operably engaged with the circular track; an idler hub that is one of the at least three hubs that are operably engaged with the circular track, the idler hub has at least three contact elements that engage an outer surface of the circular track, wherein the at least three contact elements engage a top half, a bottom half, an outer half, and an inner half of a cross section of the circular track to secure the idler hub to the circular track in vertical and horizontal directions; and a driven hub that is one of the at least three hubs that are operably engaged with the circular track, the driven hub has two contact elements that engage the outer surface of the circular track, wherein the two contact elements are arranged on opposing sides of the circular track in the vertical direction to secure the driven hub to the circular track in the vertical direction and to allow the driven hub to move relative to the track in the horizontal direction.

In some embodiments, the at least three contact elements is four contact elements that are equally spaced about the cross section of the circular track, and each of the four contact elements is offset from the horizontal and vertical directions by 45 degrees with respect to the cross section of the circular track. In various embodiments, each contact element is a roller, wherein a rotation axis of each roller is oriented substantially perpendicular to a central axis of the cross section of the circular track. In some embodiments, the contact elements for the driven hub comprise rollers that are rotatable about respective axles, and wherein the rollers are movable along a longitudinal length of the respective axles to allow the driven hub to move relative to the track in the horizontal direction. In some embodiments, each contact element is a slide element between a material of the driven or idler hubs and the outer surface of the circular track.

In various embodiments, the mounting system further comprises a second idler hub that is one of the at least three hubs that are operably engaged with the circular track, the second idler hub has at least three contact elements that engage an outer surface of the circular track, wherein the at least three contact elements engage the top half, the bottom half, the outer half, and the inner half of cross section of the circular track to secure the second idler hub to the circular track in the vertical and horizontal directions. In some embodiments, the at least three hubs is only three hubs that are equally spaced about the circular track. In various embodiments, a track support extends from an outermost point of the circular track and from a gap between adjacent contact elements to support the circular track above the ground.

A further particular embodiment of the present disclosure is an azimuth actuator system for a heliostat, comprising: a support connected to a circular track, wherein a plurality of support members extends from the support to at least three hubs that are operably engaged with the circular track; an azimuth actuator positioned proximate to one of the at least three hubs, the azimuth actuator having a plurality of rollers are arranged in a circular pattern, and the azimuth actuator rotates the plurality of rollers about a center axis of the circular pattern, wherein axes of rotation of the rollers of the plurality of rollers and the center axis are oriented in a direction substantially perpendicular to a central axis of a cross section of the circular track; and a plurality of teeth extending from the circular track, wherein each tooth has a first side and a second side descending from a distal tip of the tooth, and each of the first side and the second side have a flat portion, and wherein the plurality of rollers is biased against the plurality of teeth such that at least one roller of the plurality of rollers is engaged to the flat portions of adj acent teeth to prevent backlash between the plurality of rollers and the plurality of teeth.

In various embodiments, the mounting system further comprises a bias arm extending outward from a hub of the at least three hubs; a pivot arm rotatably connected to the bias arm between a proximal end and distal end of the bias arm, wherein the azimuth actuator is connected to the pivot arm; and a bias member extending between the distal end of the bias arm and the pivot arm to bias the azimuth actuator and the plurality of rollers into the plurality of teeth. In some embodiments, the bias member is a spring having at least one of a linear response and a nonlinear response.

In some embodiments, the bias arm is nonrotatably attached to the hub. In these embodiments, a housing is slidably engaged with the bias arm such that linear travel may occur along the axis of the bias member. This allows for the hub to accommodate variation along the bias member axis.

In various embodiments, the driven hub contains a movable carriage that contains contact elements. The movable carriage has a pivot axis on one end and a spring on the opposite side of the pivot axis. The spring is positioned such that the carriage body is located between the rail and the spring. Thus, the rollers of the carriage are in constant contact with the rail.

In some embodiments, the mounting system further comprises a driven hub that is one of the at least three hubs that are operably engaged with the circular track, the driven hub has two contact elements that engage the outer surface of the circular track, wherein the two contact elements are arranged on opposing sides of the circular track in one direction to secure the driven hub to the circular track in that direction. In various embodiments, the mounting system further comprises a first structural support extending from the driver hub to a first idler hub that is one of the at least three hubs; and a second structural support extending from the driven hub to a second idler hub that is one of the at least three hubs, wherein the driven hub, the first idler hub, and the second idler hub are equally spaced around the circular track. In some embodiments, the plurality of teeth and an additional plurality of teeth are cut from a common material, wherein the pluralities of teeth are arranged on the common material in an interleaving manner to reduce waste.

Additional features and advantages of embodiments of the present disclosure will become more readily apparent from the following description, particularly when considered together with the accompanying drawings.

### BRIEF DESCRIPTION OF THE DRAWINGS

FIG. 1 is a perspective view of a concentrating solar power plant in accordance with an embodiment of the present disclosure;

FIG. 2 is a perspective view of a heliostat in accordance with an embodiment of the present disclosure;

FIG. 3 is a perspective view of a mounting system for a heliostat in accordance with an embodiment of the present disclosure;

FIG. 4 is a perspective view of a frame for a mounting system in accordance with an embodiment of the present disclosure;

FIG. 5 is a side cross-sectional view of a hub of a mounting system in accordance with an embodiment of the present disclosure;

FIG. 6 is a side cross-sectional view of another hub of a mounting system in accordance with an embodiment of the present disclosure;

FIG. 7 is a perspective view of support members for hubs of a mounting system in accordance with an embodiment of the present disclosure;

FIG. 8 is a perspective view of support members for hubs of a mounting system in accordance with an embodiment of the present disclosure;

FIG. 9A is a perspective view of an azimuth actuator for a mounting system in accordance with an embodiment of the present disclosure;

FIG. 9B is a perspective view of an azimuth actuator for a mounting system in accordance with another embodiment of the present disclosure;

FIG. 9C is a perspective view showing the inside of an embodiment of the azimuth actuator;

FIG. 10A is a bottom plan view of azimuth rollers and track teeth in accordance with an embodiment of the present disclosure;

FIG. 10B is a bottom plan view of the azimuth rollers and track teeth in FIG. 10A in a second position in accordance with an embodiment of the present disclosure;

FIG. 11 is a perspective view of a single set of track teeth in accordance with an embodiment of the present disclosure; and

FIG. 12 is perspective view of multiple sets of track teeth in accordance with an embodiment of the present disclosure.

### DETAILED DESCRIPTION

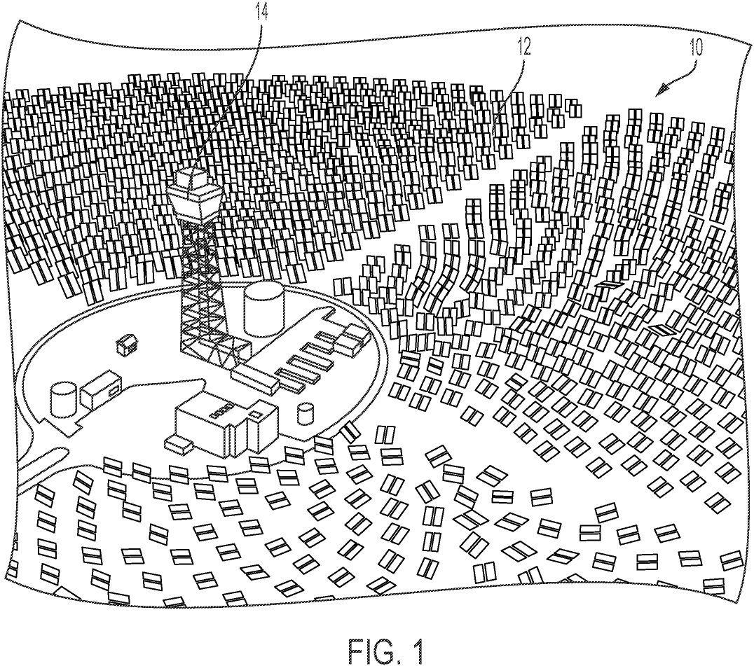

Now referring to FIG. 1, a perspective view of a concentrating solar power plant 10 with a plurality of heliostats 12 and a tower 14 is provided. The heliostats 12 have movable mirrors that reflect sunlight to a point or area at the top of the tower 14. This concentrated sunlight or radiation can then be used to, for example, heat a fluid that powers a turbine, which produces electricity. In some embodiments, water is the working fluid whereas in other embodiments molten salt (e.g., 40% potassium nitrate, 60% sodium nitrate) is the working fluid. Regardless, the heliostats 12 move with the sun to direct radiation to the point or area at the top of the tower 14.

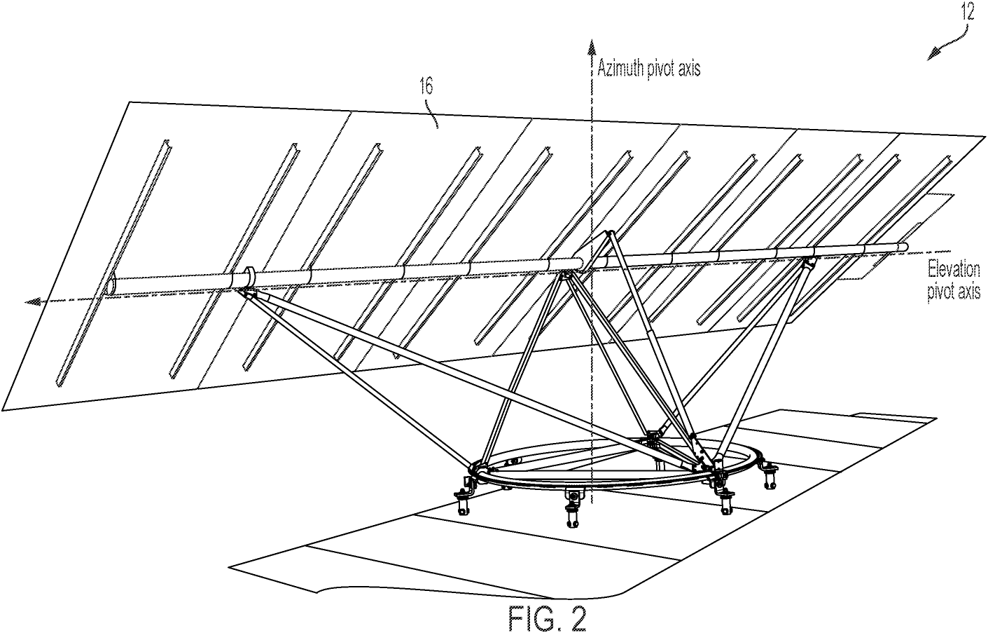

Now referring to FIG. 2, a perspective view of a heliostat 12 is provided. As shown, the heliostat 12 can comprise one or more mirrors 16 that reflect sunlight or radiation. The heliostat 12 rotates about two orthogonal axes, an elevation axis that is generally oriented horizontally and an azimuth axis that is generally oriented vertically. By controlling the movement of the heliostat 12 about these two axes, the heliostat 12 can change its orientation throughout the day to constantly direct radiation to the point at the top of the tower 14.

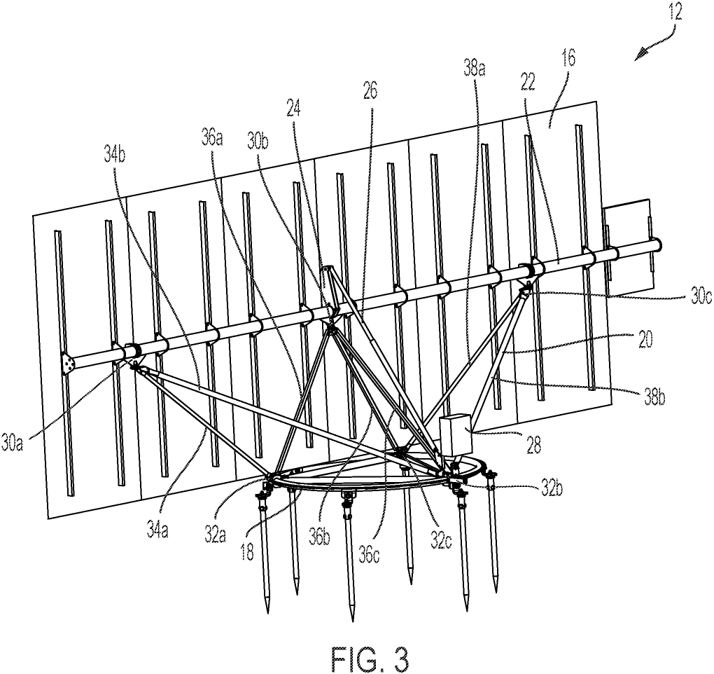

Now referring to FIG. 3, a perspective view of a mounting system 15 of a heliostat 12 and its mirrors 16 is provided. A support 22 extends along the heliostat 12 in a horizontal direction to secure the various mirrors 16. The support 22 is joined to a circular track 18 via a frame 20. The mirrors 16, the support 22, and the frame 20 rotate about the circular track 18 to change the orientation of the heliostat 12 about the azimuth axis in a carousel type of mounting system.

In addition, the orientation of the heliostat 12 about the elevation axis is adjustable. An elevation plate 24 extends from the support 22 to a distal point that is offset from the elevation axis. The elevation actuator 26 extends and retracts to move the distal end of the elevation plate 24 and rotate the support 22 relative to the frame 20 about the elevation axis. A control box 28 can house a controller device that can be in operable communication with various components, including the elevation actuator 26, to cause the components to take any action described herein.

Now referring to FIG. 3, a further perspective view of the heliostat 12 and the mounting system 5 is provided. The frame 20 is connected to three connection points 30 on the support 22 and to three hubs 32 that are operably connected to the circular track 18. In particular the support 22 has a left connection point 30a, a center connection point 30b, and a right connection point 30c. Two idler hubs 32a, 32c and a driven hub 32b are operably connected to the circular track 18 and are configured to rotate about the circular track 18. The three connection points 30a, 30b, 30c better distribute the loads and forces across the length of the support 22 and allow the support 22 to be designed with less mass, which reduces costs. Though this embodiment shows three connection points 30a, 30b, 30c on the support 22 and three hubs 32 on the circular track 18, it will be appreciated that the present disclosure encompasses embodiments with a fewer number or a greater number of connections points 30 and/or hubs 32. Moreover, it will be appreciated that the number of connection points and hubs 32 can be the same or different for a given embodiment.

A series of support members extend between the connection points 30 and the hubs 32. Support members 34a, 34b extend from the left connection point to one of the idler hubs and the driven hub, respectively. Likewise, support members 36a, 36b, 36c extend from the center connection point to each of the hubs, respectively. Finally, support members 38a, 38b extend from the right connection point to the other idler hub and the driven hub, respectively. The hubs 32 can be arranged equidistant from each other to form an equilateral triangle, and thus, the idler hubs 32a and 32c are positioned closer to the mirrors 16. This arrangement better distributes the weight of the mirrors 16 among the idler hubs 32a and 32c. As a result of this arrangement, the support members extending from the connection points 30 to the idler hubs 32a and 32c lie in a common plane and form a “W” shape. Therefore, this mounting system 15 better accommodates loads imposed on the heliostat 12 from different directions.

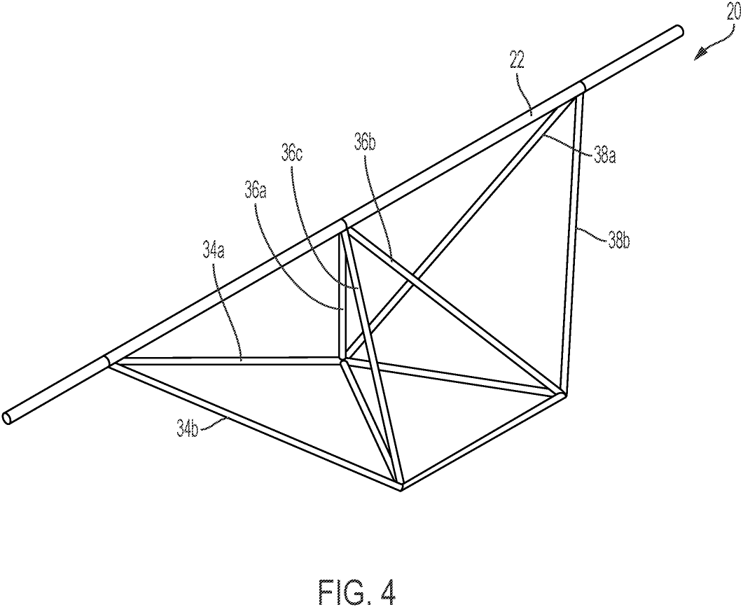

Now referring to FIG. 4, an alternative embodiment of the frame 20 is provided. In this embodiment, the driven hub 32b is positioned closer to the mirrors 16. Thus, the support members extend from the connection points 30 on the support 22 down to the idler hubs 32a and 32c in a rearward position now lie in a common plane and form the “W” shape.

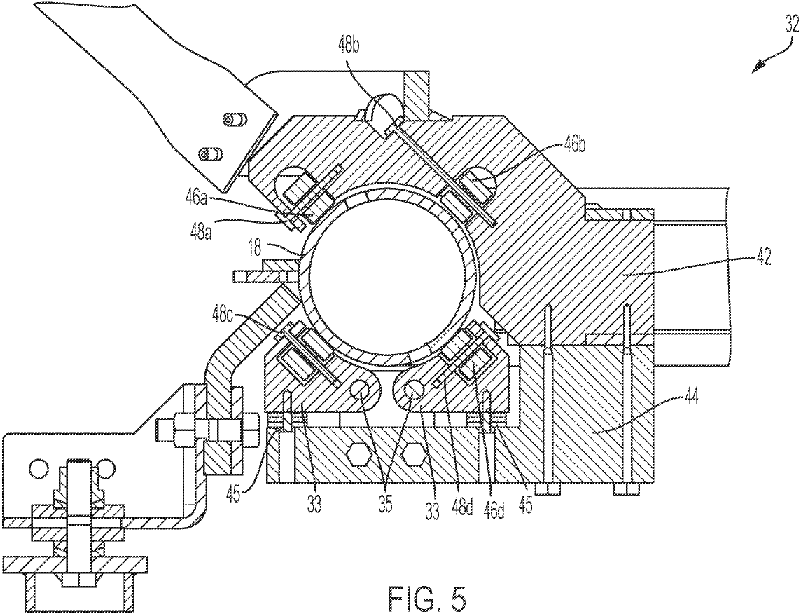

Now referring to FIG. 5, a side cross-sectional view of a hub 32 is provided. This figure shows the circular cross-sectional shape of the track 18 as well as a track support 40 that extends from an outermost surface of the track 18 to support the track 18 above a ground surface. Generally, the hub 32 in this embodiment has an upper portion 42 and a lower portion 44 that are connected to each other with, for instance, one or more fasteners such as bolts. Once connected to each other, these portions 42, 44 and the hub 32 are secured to the track 18 in the vertical and horizontal directions. The support members that form the frame 20 of the heliostat system 12 described elsewhere herein can connect to one or both of these portions 42, 44. While two portions 42, 44 are depicted, it will be appreciated that embodiments of the present disclosure can encompass any number of portions 42, 44.

Next, two contact elements 46a, 46b are positioned on an inner surface of the top portion 42 and two contact elements 46c, 46d are positioned on an inner surface of the bottom portion 44 to facilitate the movement of the hub 32 about the circular track 18. In this embodiment, each contact element 46a, 46b, 46c, 46d is a roller that rotates about a respective axis 48a, 48b, 48c, 48d that is perpendicular to an axis or line extending through a center of the circular cross section of the track 18 shown in FIG. 5. However, it will be appreciated that the contact elements 46a, 46b, 46c, 46d can be any device, coating, or other feature positioned between the hub 32 and the track 18. For instance, the contact elements 46a, 46b, 46c, 46d can each be a slide element that changes the friction coefficient between the hub 32 and the track 18. In some embodiments, this change can be an increase in the friction coefficient, and in other embodiments this change can be a decrease in the friction coefficient.

The contacts elements 46a, 46b, 46c, 46d can also be arranged in a number of ways. As shown in FIG. 5, the contact elements 46a, 46b, 46c, 46d are equally spaced around the cross section of the circular track 18. In this example, the contact elements 46a, 46b, 46c, 46d are rollers carried on axles 48a, 48b, 48c, 48d that form right angles with each other. It will be appreciated that the hub 32 may have any number of contact elements 46a, 46b, 46c, 46d. For instance, the hub 32 may have three contact elements 46 in a particular arrangement that can be described with respect to a vertical line 50 and a horizontal line 52 that divides the cross section of the track 18 into a top half, a bottom half, an outer half, and an inner half. In various embodiments, all or part of a contact element 46 is positioned in each of these halves to both support the weight of the mirrors and frame a well as secure the frame to the track 18 in the vertical and horizontal directions. An alternative embodiment with three contact elements 46 could include the first contact element 46a and second contact element 46b as shown in FIG. 5, and then, the bottom contact elements 46c, 46d are replaced with a single contact element that contacts or is configured to contact the lowermost point of the track 18. As a result, the single contact element extends into both the outer and inner halves defined by the vertical line 50, and the contact elements 32 support the weight of the mirrors and frame as well as secure the hub 32 to the track 18 in the vertical and horizontal directions.

In some embodiments, one or more of the contact elements 46 are rollers such as shown in FIG. 5. The bottom portion of the hub 32 can include a number of movable carriages 33. The embodiment of FIG. 5 shows a bottom portion of the hub 32 having two movable carriages 33 with a pivot point 35 comprised of a track or tube that runs parallel to the track 18. The pivot point 35 is located on the opposite side of the carriage 33 from the roller 46. A bias member 45 is positioned below the roller 46 with one end contacting the movable carriage 33 and the other end contacting the bottom portion of the hub 32. As a result, the roller 46 will be pushed into the track 18 and will be able to accommodate a range of irregularities within the track 18. For instance, if the track 18 experiences a worn area that causes a reduced radius, the rollers 46 will be forced into the track 18 and will maintain contact. The bias member 45 may be used on a single roller 46 or all the rollers used in the assembly. In some embodiments, the bias member 45 is a spring.

In further embodiments, the hub may include springs 45 to ensure the rollers contact the track 18. Rather than a pivot point, these embodiments can have a linear spring that pushes the roller into the track 18. In these embodiments, the bottom portion of the hub 32 may be comprised of either multiple pieces or a single bottom portion.

Though embodiments are described herein with respect to vertical and horizontal lines and directions and various halves, it will be appreciated that embodiments of the present disclosure are not limited by these descriptions and can encompass other embodiments. For example, contact elements can secure the hub to the track 18 such that the hub can move relative to the track 18 in only one direction, i.e., along the track.

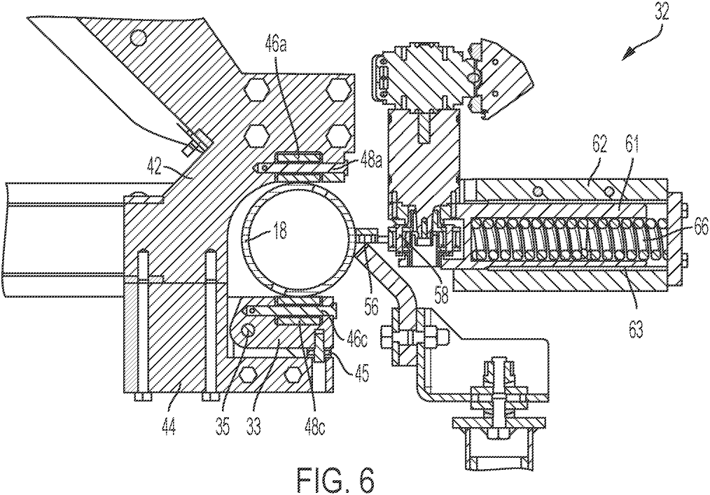

Now referring to FIG. 6, an alternative hub 32 is provided that allows for relative movement between the hub 32 and the track 18. As described above, heliostats 12 can have long lifespans in harsh environments, and in addition, the parts of the heliostat 12 may be manufactured with looser tolerances to reduce manufacturing costs. One way to satisfy these parameters is to include at least one hub 32 like the one shown in FIG. 6. This hub 32 has only two contact elements 46a, 46b, one at the top point of the track 18 and one at the bottom point of the track 18. Thus, the hub 32 in FIG. 6 can support the weight of the mirrors 16 and the frame and secure the hub 32 to the track 18 along a vertical axis 50, yet the hub 32 allows for warping or deflection along the horizontal axis 52. Thus, if the contact elements 46a, 46b are rollers, or include rollers, the respective axes 48a, 48b are parallel to each other. Specifically, the contact elements 46a, 46b can be described as rollers that move along respective axles within spaces defined by upper or lower portion of the hub 32. Each space has a larger width than the roller, and therefore, the rollers can move within the spaces along the axles in the direction of the axes 48a, 48b as the hub 32 moves about the track 18 to allow for warping or deflection. In addition, each roller can have a shape that complements the outer surface of the track 18 to both secure the rollers to the track 18 and to cause the rollers to move along the respective pins.

In some embodiments, the hub 32 contains a movable carriage 33 for at least one of the rollers 46 that is able to pivot about a point 35 on one side of the carriage 33. The carriage 33 is connected to an axle 35 that is secured on each side to the hub 32. A bias member 45, is positioned on the opposite side of the axle 35 between the hub body and the carriage body. This arrangement ensures that the contact element 46 maintains contact with the track 18 if there are variations in the track 18 dimensions. The movable carriage 33 can be found on just the bottom portion of the hub 32, just the top portion of the hub 32, or on both the top and bottom portions of the hub 32. The bias member 45 may include a spring, a piston, or other tensioners known in the art.

In further embodiments, the heliostat 12 may be configured to accommodate warping or deflection along the horizontal axis 52. As shown in FIG. 6, the sprocket 58 is mounted to a housing 61 with a biasing member 66. The housing 61 is positioned inside of a bias arm 62. The biasing member 66 is configured to create a force in the horizontal direction such that the sprocket 58 is pushed radially inwards towards the track teeth 56. This ensures that the sprocket 58 is in constant contact with the track teeth 56. FIG. 6 shows the sprocket 58 out of contact with the track teeth 56 for clarity. The housing 61 contains linear bearings 63 to allow it to slide linearly to accommodate variations in the track’s 18 diameter. In some embodiments, the linear bearings 63 may be rollers or other bearings, such as ball bearings.

It will be appreciated that in some embodiments, the hub 32 may have only a single contact element 46a located at the top point of the track 18 to support the weight of the mirrors and the frame and to accommodate or allow warping or deflection in all directions, when viewing the track 18 in cross section. In various embodiments, the hub shown in FIG. 5 is the idler hub and the hub shown in FIG. 6 is the driven hub.

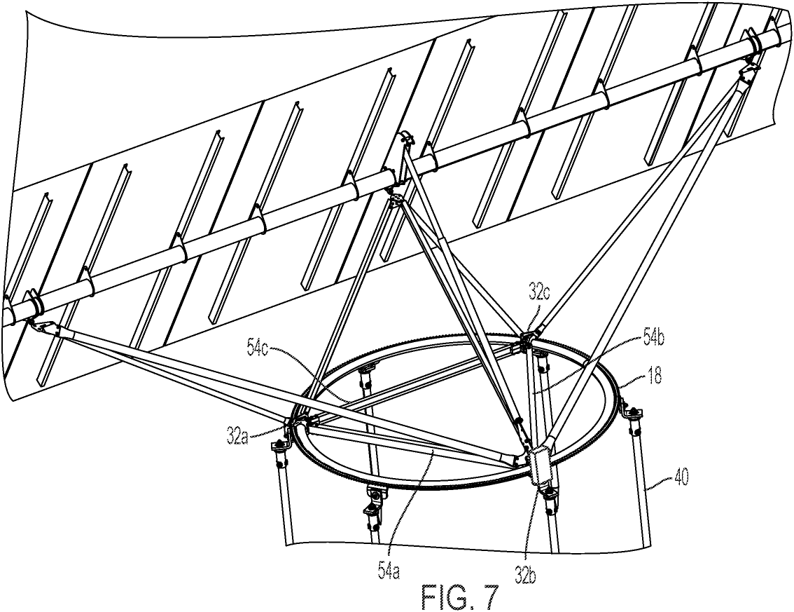

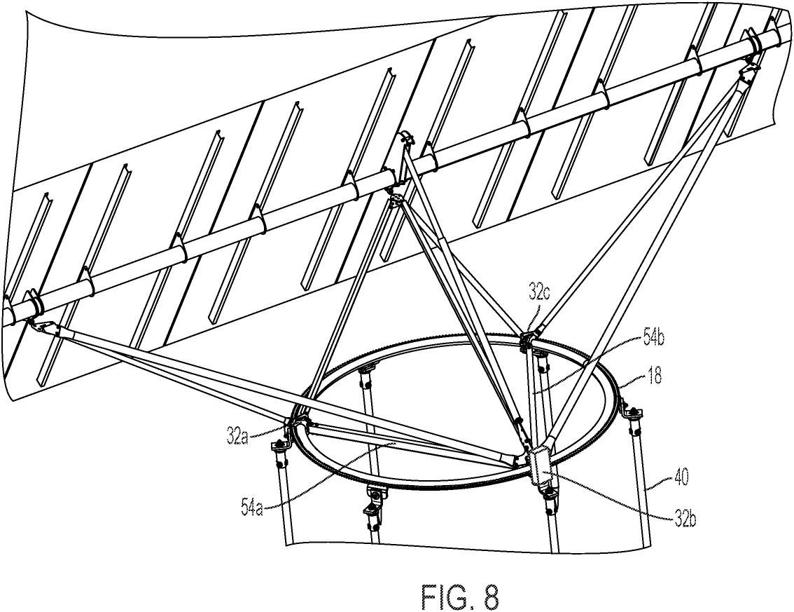

Now referring to FIGS. 7 and 8, perspective views of a track 18 and hubs 32 are provided. In FIG. 7, hub support members 54a, 54b, 54c extend between the hubs 32a, 32b, 32c to form an equilateral triangle. The hub support members 54a, 54b translate forces from the driven hub 32b to the idler hubs 32a, 32c, and support member 54c translates forces between the idler hubs 32a, 32c. The support members 54a, 54b, 54c lie in a common plane with the circular track 18 in this embodiment. To accommodate warping or deflection, only two hub support members 54a, 54b can be provided as shown in FIG. 8. The arrangement of two hub support members 54a, 54b allows a higher degree of flexing at the open end of the “V” shape formed by the hub support members 54a, 54b, which accommodates a circular track 18 that is out of round. The arrangement of the two hub support members 54a, 54b in FIG. 8 may depend on how the hubs 32a, 32b, 32c are arranged. Specifically, the driven hub 32b has an actuator or motor, which is described in further detail below, that moves the hub 32b about the track 18. With the hubs 32a, 32b, 32c and frame connected to each other, movement of the driven hub 32b moves all of the hubs 32a, 32b, 32c and frame about the azimuth axis. Thus, with two support members 54a, 54b, the support members 54a, 54b extend from the driven hub 32b to the other two hubs 32a, 32c to better distribute forces when the azimuth actuator moves the driven hub 32b. Moreover, it will be appreciated that, for the embodiments shown in FIGS. 7 and 8, the hubs 32a, 32b, 32c may not be equally spaced around the track 18 to form an equilateral triangle. In some embodiments, the driven hub 32b, forms an angle that is greater than or less than 60 degrees with the other two hubs 32a, 32c.

To simplify the heliostat 12, it is preferable to have one driven hub 32b and two idler hubs 32a, 32b. In FIG. 8, the frame is arranged with two hubs 32a, 32c in a forward position and one hub 32b in a rearward position. This is preferable since any maintenance of the motor or actuator associated with the driven hub 32b is easier since the hub 32b is more accessible in the rear position. Further still, the driven hub 32b can be described as having fewer contact elements or points of contact when compared to the idler hubs 32a, 32c to match the functionality of the azimuth actuator described below and to accommodate warping or deflection in the track 18 or any other part of the heliostat. Moreover, various embodiments of the present disclosure comprise three total hubs 32, of which two are idler hubs 32a and 32c and one is a driven hub 32b. However, it will be appreciated that embodiments of the present disclosure encompass any combination or variation of idler hubs 32a and 32c and driven hubs 32b. For example, one or more of the idler hubs 32a and 32c can have the same number of contact elements 46 as the hub 32 shown in FIG. 6. Some embodiments may comprise more than one driven hub 32b. In addition, the hubs 32, whether idler hubs 32a and 32c or driven hubs 32b, can be positioned at any point on the circular track 18 and in any position relative to the frame and/or mirrors 16 of the heliostat 12.

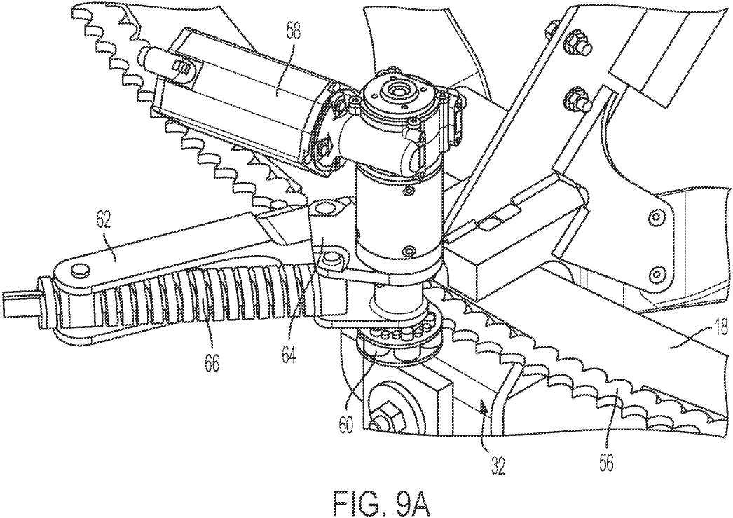

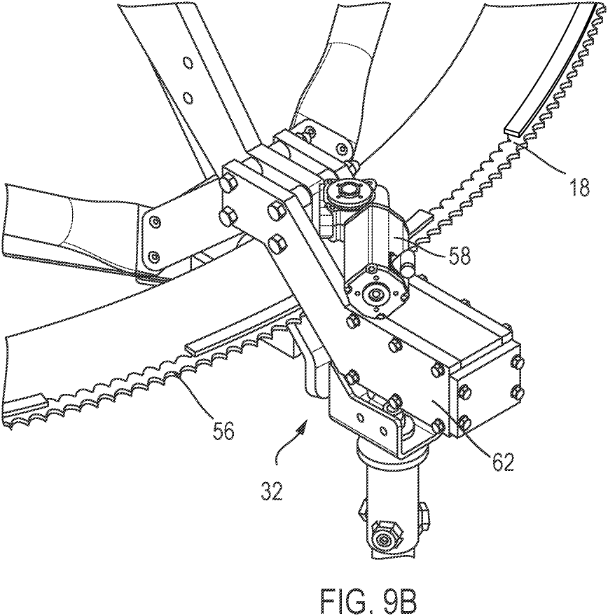

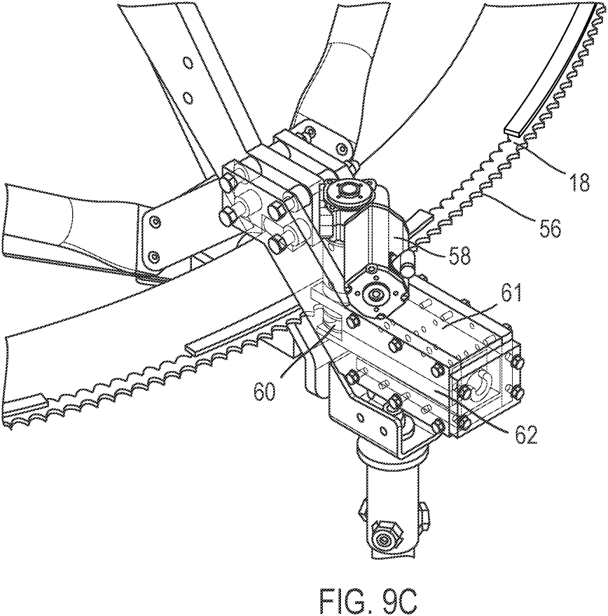

Now referring to FIG. 9, a perspective view of a driven hub 32b and an azimuth actuator 58 is provided. The actuator 58 rotates a plurality of rollers 60 that operably engage a set of teeth 56 extending from the circular track 18. The plurality of rollers 60 rotate about a vertical axis to move the driven hub 32b about the track 18.

In addition, the actuator 58 and rollers 60 are biased against the track 18 to accommodate warping or deflection of the track 18. A bias arm 62 extends outwardly from the driven hub 32b to a distal end, and a pivot arm 64 is rotatably connected to the bias arm 62 at a point between the track 18 and the distal end. The azimuth actuator 58 and the rollers 60 are connected to the pivot arm 64, and a bias member 66 extends between the bias arm 62 and the pivot arm 64 to rotate the pivot arm 64 about its connection to the bias arm 62. As a result, the actuator 58 and the rollers 60 are biased into the teeth 56 of the track 18 to maintain the operable connection between the rollers 60 and the teeth 56, even if the track 18 or other structure has warped or deflected. It will be appreciated that the bias member 66 can be a spring or other similar feature with a linear and/or non-linear response. In an alternative to the embodiment shown in FIG. 9, the pivot arm 64 and/or the azimuth actuator 58 can be biased along a linear guide track to allow for movement in the radial direction of the circular track 18. One of these alternative embodiments having a linear guide track is shown in FIG. 6.

In some embodiments, as shown in FIGS. 9B and 9C, the actuator 58 and rollers 60 are held in constant engagement with the track 18 by using a linear bias element 66 instead of a pivot arm 64 and bias arm 62. In these embodiments, the rollers 60 are connected to a housing 61 containing a bias member 66. The housing 61 is seated inside a bias arm 62 having a friction reducing element 63, shown as linear bearings 63 in FIG. 6, which allow the housing 61 to slide linearly towards and away from the teeth 68 of the track 18. The housing 61 is connected to the bias arm 62 in a non-pivoting manner such that the bias member 66 always forces the rollers 60 into the teeth 56 of the track 18. In this manner, the rollers 60 will stay in contact with the teeth 56 if the structure has warped or deflected in the horizontal direction.

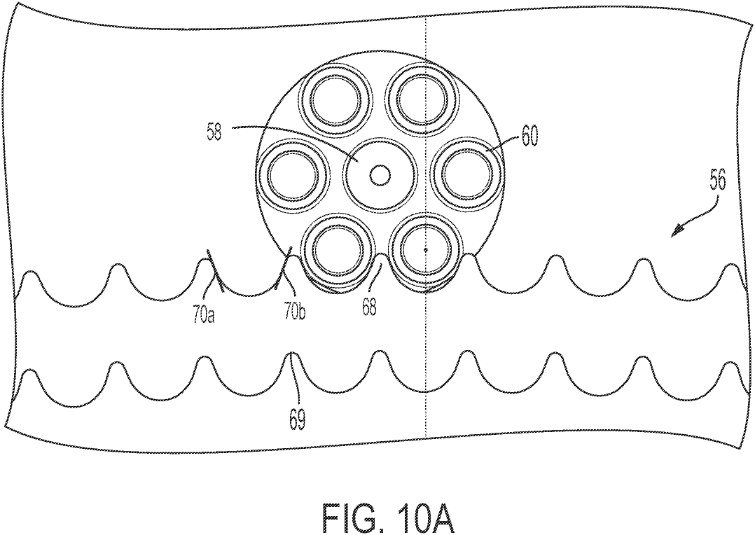

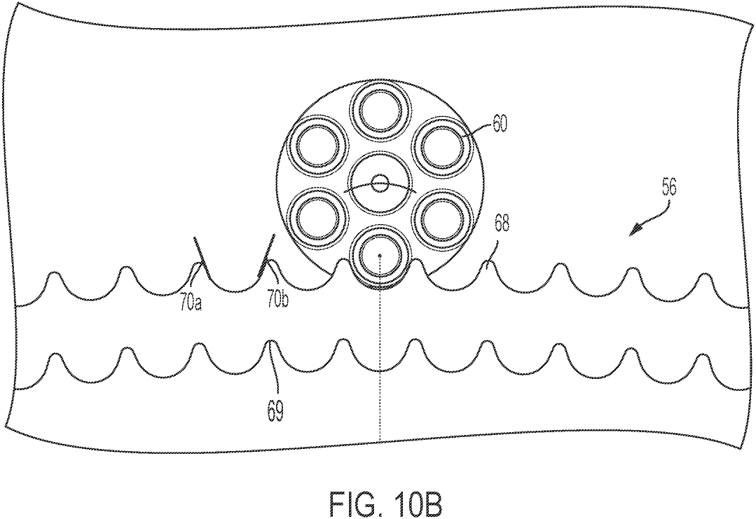

Now referring to FIGS. 10A and 10B, bottom plan views of the rollers 60 and the teeth 56 are provided. The set of teeth 56 comprises individual teeth 68 that extend from a base to a distal end or tip. Each tooth 68 has a first side and a second side that descend from the distal end or tip to join adjacent teeth. Each one of these sides has a flat portion 70a, 70b. Each of these teeth 68 can correspond to a negative tooth 69 on the back side of the track created by the manufacturing process as discussed in detail below. When a roller 60 contacts adjacent teeth, the roller 60 contacts the bearing surface of the adjacent teeth to reduce or eliminate swaying or residual movements between the mirrors and frame combination and the track 18. In FIG. 10A, two rollers 60 contact the bearing surface of the teeth or three different teeth 68. In FIG. 10B, the azimuth actuator has rotated the plurality of rollers 60 and now a single roller 60 engages the flat portions 70a, 70b on two adjacent teeth. Thus, regardless of the position of the plurality of rollers 60, at least one roller 60 contacts at least two flat portions to prevent the swaying and residual movement. In addition, FIGS. 10A and 10B show that as the plurality of rollers 60 rotates, the center axis of the plurality of rollers 60 moves in an arcing or curved line. The bias member and biasing system in FIG. 9 accommodates this motion.

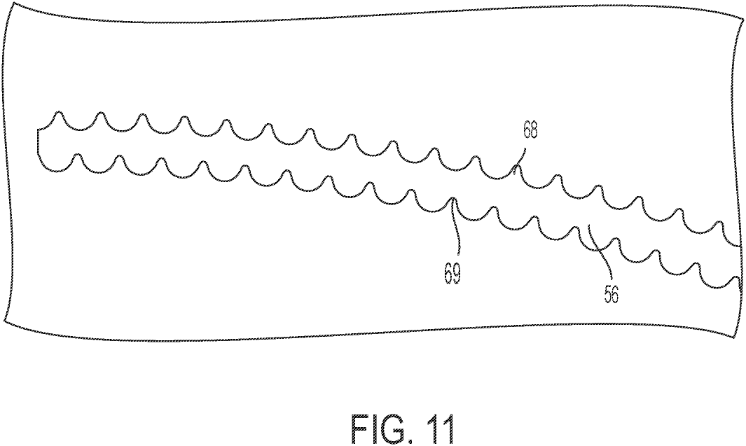

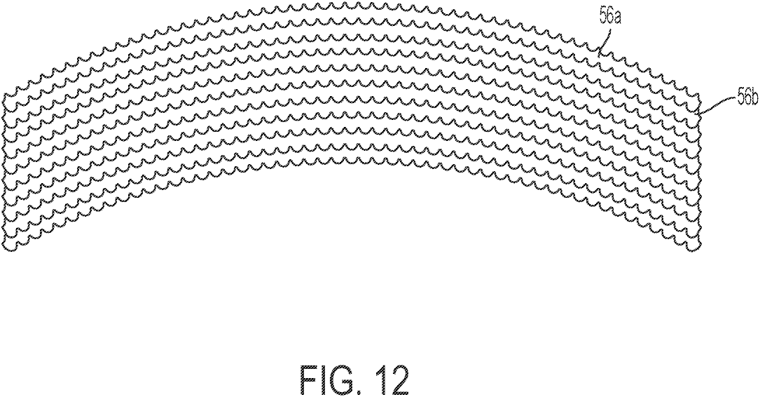

Now referring to FIGS. 11 and 12, perspective views of the set of teeth 56 are provided. As shown in FIG. 12, the teeth 56 can be cut from the same sheet of material in an interleaving manner to reduce waste. This creates a tooth 68 on an engaging side of the track and a negative tooth 69 on the inside of each track of teeth 56 as shown in FIG. 11.

In accordance with at least some embodiments of the present disclosure, the technology encompasses:

A mounting system for a heliostat, comprising:
a support having a left connection point, a center connection point, and a right connection point;
a circular track having a left idler hub, a right idler hub, and a driven hub, wherein the hubs are configured to move about the circular track;
two support members extending from the left connection point, wherein one of the support members extending from the left connection point is connected to the left idler hub, and one of the support members extending from the left connection point is connected to the driven hub;
three support members extending from the center connection point, wherein one of the support members extending from the center connection point is connected to the left idler hub, one of the support members extending from the center connection point is connected to the driven hub, and one of the support members extending from the center connection is connected to the right idler hub; and
two support members extending from the right connection point, wherein one of the support members extending from the right connection point is connected to the driven hub, and one of the support members extending from the right connection point is connected to the right idler hub.

The mounting system of (1), further comprising:

an elevation actuator positioned proximate to the driven hub and connected to a point that is offset from an elevation pivot axis, wherein the left connection point, the center connection point, and the right connection point are arranged along the elevation pivot axis, wherein the elevation actuator extends and retracts to rotate the support about the elevation pivot axis.

The mounting system of (1) or (2), further comprising:
an azimuth actuator connected to the driven hub, the azimuth actuator having a plurality of rollers are arranged in a circular pattern, and the azimuth actuator rotates the plurality of rollers about a center axis of the circular pattern; and
a plurality of teeth extending from the circular track, wherein the plurality of rollers is operably engaged with the plurality of teeth, the azimuth actuator and the plurality of rollers are biased against the plurality of teeth, and rotation of the rollers against the teeth moves the driven hub about the circular track.

The mounting system of (3), wherein each tooth of the plurality of teeth has two sides that descend from a tip, and each side has a flat portion, wherein at least one roller of the plurality of rollers is engaged to the flat portions of adj acent teeth to prevent backlash between the plurality of rollers and the plurality of teeth.

The mounting system of (1)-(4), further comprising:
a first support member extending from the driven hub to the left idler hub; and
a second support member extending from the driven hub to the right idler hub.

The mounting system of (1)-(4), further comprising:
a first support member extending between the driven hub and the left idler hub;
a second support member extending between the driven hub and the right idler hub; and
a third support member extending between the left idler hub and the right idler hub.

The mounting system of (1)-(6), wherein the azimuth actuator is in operable connection with a bias arm comprising a housing and a linear spring, the bias arm being secured along a radial distance of the circular track, and the linear spring arranged such that the rollers of the azimuth actuator are biased towards the teeth of the track.

A hub system for a heliostat, comprising:
a support connected to a circular track, wherein a plurality of support members extends from the support to at least three hubs that are operably engaged with the circular track;
an idler hub that is one of the at least three hubs that are operably engaged with the circular track, the idler hub has at least three contact elements that engage an outer surface of the circular track, wherein the at least three contact elements engage a top half, a bottom half, an outer half, and an inner half of a cross section of the circular track to secure the idler hub to the circular track in vertical and horizontal directions; and
a driven hub that is one of the at least three hubs that are operably engaged with the circular track, the driven hub has two contact elements that engage the outer surface of the circular track, wherein the two contact elements are arranged on opposing sides of the circular track in the vertical direction to secure the driven hub to the circular track in the vertical direction and to allow the driven hub to move relative to the track in the horizontal direction.

The hub system of (8), wherein the at least three contact elements is four contact elements that are equally spaced about the cross section of the circular track, and each of the four contact elements is offset from the horizontal and vertical directions by 45 degrees with respect to the cross section of the circular track.

The hub system of (8) or (9), wherein each contact element is a roller, wherein a rotation axis of each roller is oriented substantially perpendicular to a central axis of the cross section of the circular track.

The hub system of (8) to (10), wherein the contact elements for the driven hub comprise rollers that are rotatable about respective axles, and wherein the rollers are movable along a longitudinal length of the respective axles to allow the driven hub to move relative to the track in the horizontal direction.

The hub system of (8) or (9), wherein each contact element is a slide element between a material of the driven or idler hubs and the outer surface of the circular track.

The hub system of (8) to (12), further comprising:

a second idler hub that is one of the at least three hubs that are operably engaged with the circular track, the second idler hub has at least three contact elements that engage an outer surface of the circular track, wherein the at least three contact elements engage the top half, the bottom half, the outer half, and the inner half of cross section of the circular track to secure the second idler hub to the circular track in the vertical and horizontal directions.

The hub system of (8) to (13), wherein each of the contact elements of the idler hubs are positioned on a plurality of movable carriages, the movable carriage being secured to the idler roller by a pivot point located at one side of the carriage, and a bias member positioned between a surface of the idler hub and the movable carriage such that the contact element is biased towards the track.

An azimuth actuator system for a heliostat, comprising:
a support connected to a circular track, wherein a plurality of support members extends from the support to at least three hubs that are operably engaged with the circular track;
an azimuth actuator positioned proximate to one of the at least three hubs, the azimuth actuator having a plurality of rollers arranged in a circular pattern, and the azimuth actuator rotates the plurality of rollers about a center axis of the circular pattern, wherein axes of rotation of the rollers of the plurality of rollers and the center axis are oriented in a direction substantially perpendicular to a central axis of a cross section of the circular track; and
a plurality of teeth extending from the circular track, wherein each tooth has a first side and a second side descending from a distal tip of the tooth, and each of the first side and the second side have a flat portion, and wherein the plurality of rollers is biased against the plurality of teeth such that at least one roller of the plurality of rollers is engaged to the flat portions of adjacent teeth to prevent backlash between the plurality of rollers and the plurality of teeth.

The azimuth actuator system of (15), further comprising:
a bias arm extending outward from a hub of the at least three hubs;
wherein the bias arm is secured along a radial distance from the hub;
wherein the azimuth actuator is connected to the bias arm; and
a bias member positioned inside a housing of the bias arm to bias the azimuth actuator and the plurality of rollers into the plurality of teeth, the housing being slidingly engaged with the bias arm.

The azimuth actuator system of (15) or (16), further comprising:
a driven hub that is one of the at least three hubs that are operably engaged with the circular track, the driven hub has two contact elements that engage the outer surface of the circular track, wherein the two contact elements are arranged on opposing sides of the circular track in one direction to secure the driven hub to the circular track in that direction.

The azimuth actuator system of (17), further comprising:
a first structural support extending from the driven hub to a first idler hub that is one of the at least three hubs; and
a second structural support extending from the driven hub to a second idler hub that is one of the at least three hubs, wherein the driven hub, the first idler hub, and the second idler hub are equally spaced around the circular track.

The azimuth actuator system of (15) to (18), wherein the plurality of teeth and an additional plurality of teeth are cut from a common material, wherein the pluralities of teeth are arranged on the common material in an interleaving manner to reduce waste.

The azimuth actuator system of (16) to (19), wherein the bias member is a spring having at least one of a linear response and a nonlinear response

A method of mounting an adjustable heliostat system, the method comprising:
providing a support system comprising:
   a frame;
   a circular track;
   a toothed ring proximal the circular track;
placing a plurality of idler hubs and at least one driven hub on the track, the at least one driven hub having a motor driving a sprocket in geared connection with the toothed ring;
   wherein the plurality of idler hubs and the at least one driven hub are able to move about the circular track via contact elements;
providing a mirror having a plurality of support bars connected to the plurality of idler hubs and the at least one driven hub;
providing an azimuth actuator on the at least one driven hub;
   the azimuth actuator being able to adjust the mirrors angle with respect to the horizon;
programming the at least one driven hub to move around the track and the azimuth actuator to move the mirror according to the sun’s position.

The foregoing discussion has been presented for purposes of illustration and description. Further, the description is not intended to limit the disclosed structures, systems and methods to the forms disclosed herein. Consequently, variations and modifications commensurate with the above teachings, within the skill or knowledge of the relevant art, are within the scope of the present disclosure. The embodiments described hereinabove are further intended to explain the best mode presently known of practicing the disclosed structures, systems and methods, and to enable others skilled in the art to utilize the disclosed structures, systems and methods in such or in other embodiments and with various modifications required by the particular application or use. It is intended that the appended claims be construed to include alternative embodiments to the extent permitted by the prior art.

What is claimed is:

1. A mounting system for a heliostat, comprising:
a support having a left connection point, a center connection point, and a right connection point;
a circular track having a left idler hub, a right idler hub, and a driven hub, wherein the hubs are configured to move about the circular track;
two support members extending from the left connection point, wherein one of the support members extending from the left connection point is connected to the left idler hub, and one of the support members extending from the left connection point is connected to the driven hub;
three support members extending from the center connection point, wherein one of the support members extending from the center connection point is connected to the left idler hub, one of the support members extending from the center connection point is connected to the driven hub, and one of the support members extending from the center connection is connected to the right idler hub; and
two support members extending from the right connection point, wherein one of the support members extending from the right connection point is connected to the driven hub, and one of the support members extending from the right connection point is connected to the right idler hub.

2. The mounting system of claim 1, further comprising:
an elevation actuator positioned proximate to the driven hub and connected to a point that is offset from an elevation pivot axis, wherein the left connection point, the center connection point, and the right connection point are arranged along the elevation pivot axis, wherein the elevation actuator extends and retracts to rotate the support about the elevation pivot axis.

3. The mounting system of claim 1, further comprising:
an azimuth actuator connected to the driven hub, the azimuth actuator having a plurality of rollers arranged in a circular pattern, and the azimuth actuator rotates the plurality of rollers about a center axis of the circular pattern; and
a plurality of teeth extending from the circular track, wherein the plurality of rollers is operably engaged with the plurality of teeth, the azimuth actuator and the plurality of rollers are biased against the plurality of teeth, and rotation of the rollers against the teeth moves the driven hub about the circular track.

4. The mounting system of claim 3, wherein each tooth of the plurality of teeth has two sides that descend from a tip, and each side has a flat portion, wherein at least one roller of the plurality of rollers is engaged to the flat portions of adj acent teeth to prevent backlash between the plurality of rollers and the plurality of teeth.

5. The mounting system of claim 1, further comprising:
a first support member extending from the driven hub to the left idler hub; and
a second support member extending from the driven hub to the right idler hub.

6. The mounting system of claim 1, further comprising:
a first support member extending between the driven hub and the left idler hub;
a second support member extending between the driven hub and the right idler hub; and
a third support member extending between the left idler hub and the right idler hub.

7. The mounting system of claim 1, wherein the azimuth actuator is in operable connection with a bias arm comprising a housing and a linear spring;
the bias arm being secured along a radial distance of the circular track;
the linear spring arranged such that the rollers of the azimuth actuator are biased towards the teeth of the track..

8. A hub system for a heliostat, comprising:
a support connected to a circular track, wherein a plurality of support members extends from the support to at least three hubs that are operably engaged with the circular track;
an idler hub that is one of the at least three hubs that are operably engaged with the circular track, the idler hub has at least three contact elements that engage an outer surface of the circular track, wherein the at least three contact elements engage a top half, a bottom half, an outer half, and an inner half of a cross section of the circular track to secure the idler hub to the circular track in vertical and horizontal directions; and
a driven hub that is one of the at least three hubs that are operably engaged with the circular track, the driven hub has two contact elements that engage the outer surface of the circular track, wherein the two contact elements are arranged on opposing sides of the circular track in the vertical direction to secure the driven hub to the circular track in the vertical direction and to allow the driven hub to move relative to the track in the horizontal direction.

9. The hub system of claim 8, wherein the at least three contact elements is four contact elements that are equally spaced about the cross section of the circular track, and each of the four contact elements is offset from the horizontal and vertical directions by 45 degrees with respect to the cross section of the circular track.

10. The hub system of claim 8, wherein each contact element is a roller, wherein a rotation axis of each roller is oriented substantially perpendicular to a central axis of the cross section of the circular track.

11. The hub system of claim 8, wherein the contact elements for the driven hub comprise rollers that are rotatable about respective axles, and wherein the rollers are movable along a longitudinal length of the respective axles to allow the driven hub to move relative to the track in the horizontal direction.

12. The hub system of claim 8, wherein each contact element is a slide element between a material of the driven or idler hubs and the outer surface of the circular track.

13. The hub system of claim 8, further comprising:
a second idler hub that is one of the at least three hubs that are operably engaged with the circular track, the second idler hub has at least three contact elements that engage an outer surface of the circular track, wherein the at least three contact elements engage the top half, the bottom half, the outer half, and the inner half of cross section of the circular track to secure the second idler hub to the circular track in the vertical and horizontal directions.

14. The hub system of claim 8, wherein one or more of the contact elements of the idler hubs are positioned on a plurality of movable carriages;
the movable carriage secured to the idler roller by a pivot point located at one side of the carriage;
a bias member positioned between a surface of the idler hub and the movable carriage, the contact element being biased towards the circular track.

15. An azimuth actuator system for a heliostat, comprising:
a support connected to a circular track, wherein a plurality of support members extends from the support to at least three hubs that are operably engaged with the circular track;
an azimuth actuator positioned proximate to one of the at least three hubs, the azimuth actuator having a plurality of rollers are arranged in a circular pattern, and the azimuth actuator rotates the plurality of rollers about a center axis of the circular pattern, wherein axes of rotation of the rollers of the plurality of rollers and the center axis are oriented in a direction substantially perpendicular to a central axis of a cross section of the circular track; and
a plurality of teeth extending from the circular track, wherein each tooth has a first side and a second side descending from a distal tip of the tooth, and each of the first side and the second side have a flat portion, and wherein the plurality of rollers is biased against the plurality of teeth such that at least one roller of the plurality of rollers is engaged to the flat portions of adjacent teeth to prevent backlash between the plurality of rollers and the plurality of teeth.

16. The azimuth actuator system of claim 15, further comprising:
a bias arm extending outward from a hub of the at least three hubs;
wherein the bias arm is secured along a radial distance from the hub;
wherein the azimuth actuator is connected to the bias arm; and
a bias member positioned inside a housing of the bias to bias the azimuth actuator and the plurality of rollers into the plurality of teeth, the housing being slidingly engaged with the bias arm.

17. The azimuth actuator system of claim 15, further comprising:
a driven hub that is one of the at least three hubs that are operably engaged with the circular track, the driven hub has two contact elements that engage the outer surface of the circular track, wherein the two contact elements are arranged on opposing sides of the circular track in one direction to secure the driven hub to the circular track in that direction.

18. The azimuth actuator system of claim 18, further comprising:
a first structural support extending from the driven hub to a first idler hub that is one of the at least three hubs; and
a second structural support extending from the driven hub to a second idler hub that is one of the at least three hubs, wherein the driven hub, the first idler hub, and the second idler hub are equally spaced around the circular track.

19. The azimuth actuator system of claim 15, wherein the plurality of teeth and an additional plurality of teeth are cut from a common material, wherein the pluralities of teeth are arranged on the common material in an interleaving manner to reduce waste.

20. A method of mounting a mirror of an adjustable heliostat system, the method comprising:
providing a support system comprising:
a frame;
a circular track;
a toothed ring proximal the circular track;
placing a plurality of idler hubs and at least one driven hub on the track, the at least one driven hub having a motor driving a sprocket in geared connection with the toothed ring;
wherein the plurality of idler hubs and the at least one driven hub are able to move about the circular track via contact elements;
providing a mirror having a plurality of support bars connected to the plurality of idler hubs and the at least one driven hub;
providing an azimuth actuator on the at least one driven hub;
the azimuth actuator being able to adjust the mirrors angle with respect to the horizon;
controlling the at least one driven hub to move around the track and the azimuth actuator to move the mirror according to the sun’s position.
